(19) United States
(12) Patent Application Publication
(10) Pub. No.: US 2013/0153593 A1
(43) Pub. Date: Jun. 20, 2013

(54) APPARATUS, SYSTEM AND METHOD FOR DISPENSING PET TRAINING PADS

(71) Applicant: Jeff Silagy, Merrick, NY (US)

(72) Inventor: Jeff Silagy, Merrick, NY (US)

(21) Appl. No.: 13/343,060

(22) Filed: Jan. 4, 2012

Related U.S. Application Data
(60) Provisional application No. 61/576,600, filed on Dec. 16, 2011.

(51) Int. Cl. B65D 83/08; B65G 59/02

(52) U.S. Cl. 221/1; 206/494; 221/282; 221/279; 221/45; 221/46

(57) ABSTRACT

An apparatus for dispensing pet training pads includes a base defining a base axis and having an internal chamber, and a support disposed within the internal chamber of the base. The support is arranged to support at least two pet training pads in superposed relation. The support is dimensioned and adapted to translate within the internal chamber along the base axis to direct the pet training pads toward an access opening associated with the base to permit individual and/or sequential removal of the training pads through the access opening by the user.

### CROSS-REFERENCE TO RELATED APPLICATION(S)

This application claims priority to, and the benefit of, U.S. Provisional Application Ser. No. 61/576,600, filed on Dec. 16, 2011.

### BACKGROUND

1. Technical Field

The present disclosure is directed to an apparatus, system and method for dispensing training pads used in conjunction with, e.g., the training of pets such as dogs or cats.

2. Discussion of Related Art

Training pads or products for training or housebreaking pets such as dogs or cats are known in the art. Typically, a pet training pad is placed on the floor in a defined room in the residence and provides an area in which the pet may answer nature's call. Training pads also have application with older pets with incontinence issues or may prove useful when walking the pet is impractical due to the age or health of the pet owner, extended absence of the owner, weather concerns or impracticality due to the location of the residence, e.g., in a high rise apartment complex.

Training pads are typically purchased in large volume and must be stored in an appropriate storage place such as a cabinet or a closet. Such storage of training pads presents concerns with respect to accessibility of a training pad for immediate use, clutter of the stored pads, etc.

### SUMMARY

Accordingly, the present disclosure is directed to a system for providing neat and controlled storage and dispensing of pet training pads. In accordance with one embodiment of the present disclosure, an apparatus for dispensing pet training pads includes a base defining a base axis and having an internal chamber, and a support disposed within the internal chamber of the base. The support is arranged to support at least two pet training pads in superposed relation. The support is dimensioned and adapted to translate within the internal chamber along the base axis to direct the pet training pads toward an access opening associated with the base to permit individual and/or sequential removal of the training pads through the access opening by the user.

The apparatus may include a biasing member in operative engagement with the support, and dimensioned to bias the support to translate along the base axis toward the access opening. The biasing member may include a spring disposed in operative engagement with the support. As a further alternative, first and second springs may be in operative engagement with the support and cooperate to bias the support toward the access opening.

A lid may be mounted to the base and defines a lid aperture, which serves as the access opening. The lid may be adapted to move between an open position to permit loading of the internal chamber of the base with training pads and a closed position to substantially enclose the internal chamber. The lid may be pivotally mounted to the base, and be adapted to pivot between the open position and the closed position.

The apparatus may include a plurality of pet training pads arranged in at least partial superposed relation within the internal chamber of the base. Each training pad may be folded and define at least a first edge. The first edge is positioned in general alignment with the access opening to face the opening to thereby facilitate grasping of the training pad by the user. The training pad also may be folded to define at least first and second edges. The first and second edges may be in juxtaposed relation and positioned in general alignment with the access opening also to face the opening.

The apparatus may include a package having an outer cover and a plurality of pet training pads in superposed relation within the outer cover. The outer cover may be removable to permit removal of the training pads for positioning within the internal chamber of the base. Each training pad within the package may be folded and has at least a first edge with the first edges of the pads facing in the same direction within the package. Each training pad within the package further may be folded to provide at least first and second edges being in juxtaposed relation and positioned in the same direction within the package.

In accordance with another aspect of the present disclosure, a package for use with a dispenser includes an outer cover and a plurality of absorbent pet training pads at least partially enclosed by the outer cover. Each training pad may be folded upon itself to define a folded training pad having at least one edge exposed outwardly of the folded training pad. At least some of the folded training pads may be arranged in superposed relation with the at least one edge facing in the same direction within the outer cover. Each folded training pad has at least first and second edges exposed outwardly of the folded training pad with at least some of the folded training pads arranged in superposed relation with the first and second edges facing in the same direction within the outer cover.

Each training pad may define a central longitudinal midline dividing the training pad into longitudinal sections, and at least one substantial longitudinal fold line on each side of the central longitudinal midline. Each longitudinal section may be folded upon itself along the at least one longitudinal fold line thereby providing first and second edges adjacent the longitudinal midline. Each training pad may include at least two substantial longitudinal fold lines on each side of the central longitudinal midline. Each longitudinal section may be folded upon itself along the at least two longitudinal fold lines thereby providing first and second edges adjacent the longitudinal midline. Each training pad further may define a medial transverse fold line orthogonal to the central longitudinal midline to define first and second transverse sections of each training pad. The first and second transverse sections may be folded onto each other along the medial fold line to present the first and second edges outwardly of the folded training pad.

In accordance with another aspect of the present disclosure, a method is provided. The method includes the steps of:

a) providing a plurality of absorbent pet training pads, each training pad defining a central longitudinal axis and a transverse axis orthogonal to the central longitudinal axis, each pet training pad having first and second longitudinal sections defined on respective sides of the central longitudinal axis;

b) folding the first longitudinal section of each training pad along at least one longitudinal fold line extending within the first longitudinal section to position a first edge of the training pad adjacent the central longitudinal axis;

c) folding the second longitudinal section of each training pad along at least one longitudinal fold line extending within the second longitudinal section to position a second edge of the training pad adjacent the central longitudinal axis;

d) positioning the training pads within an internal chamber of a dispenser in superposed relation such that the first and second edges of each training pad face outwardly toward an access opening of the dispenser;

e) moving a support within the internal chamber of the dispenser to advance the training pads toward the access opening; and

f) removing the outermost training pad adjacent the access opening from the dispenser by grasping the outermost training pad adjacent at least one of the first and second edges thereof.

Other embodiments are also envisioned.

### BRIEF DESCRIPTION OF THE DRAWING(S)

Preferred embodiments of the present disclosure will be better understood by reference to the drawings wherein:

FIG. 1 is a perspective view of the apparatus for dispensing pet training pads in accordance with the principles of the present disclosure, illustrating the base, the lid and training pads accessible through a lid aperture of the lid;

FIG. 2 is a side plan view of the apparatus of FIG. 1;

FIG. 3 is a perspective view of the apparatus of FIG. 1 illustrating the lid in an open position;

FIG. 4 is a top plan view of the apparatus of FIG. 1;

FIG. 5 is a side cross-sectional view of the apparatus of FIG. 1 illustrating the internal chamber of the base, the support, and the biasing springs;

FIG. 6 is a plan view of the training pad for use with the apparatus of FIG. 1;

FIGS. 7-12 are views illustrating a sequence of steps for folding the training pad for placement within the internal chamber of the base;

FIG. 13 is a view illustrating removal of a training pad through the lid aperture of the lid;

FIGS. 14A-14C are views illustrating alternate methods for folding the training pad for placement within the internal chamber of the base;

FIGS. 15-17 are views illustrating another alternate sequence of steps for folding the training pad for placement within the internal chamber of the base;

FIG. 18 is a view illustrating an alternate arrangement for folding the training pad;

FIG. 19 is a view illustrating a package incorporating a plurality of training pads for use with the apparatus of FIG. 1; and

FIG. 20 is a side cross-sectional view of an alternate embodiment of the apparatus of FIG. 1.

### DETAILED DESCRIPTION

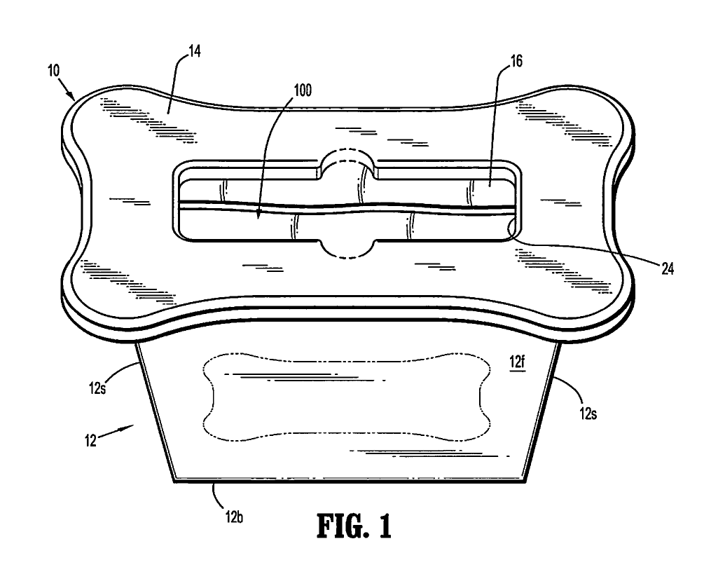

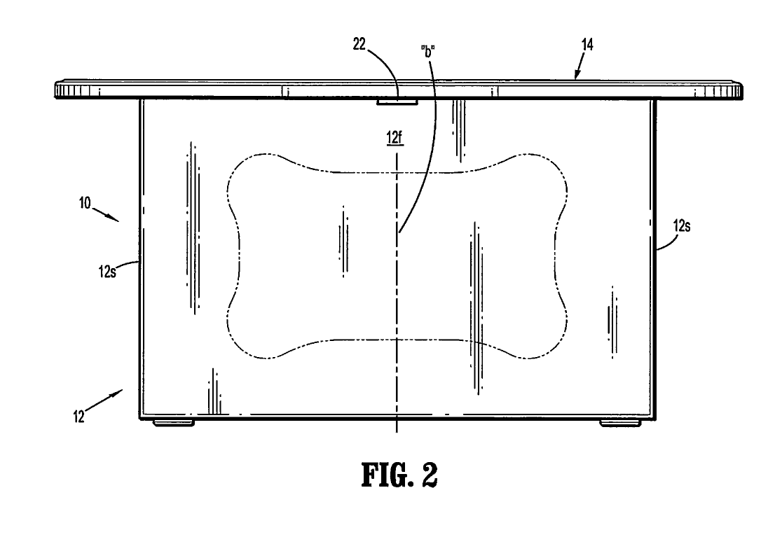

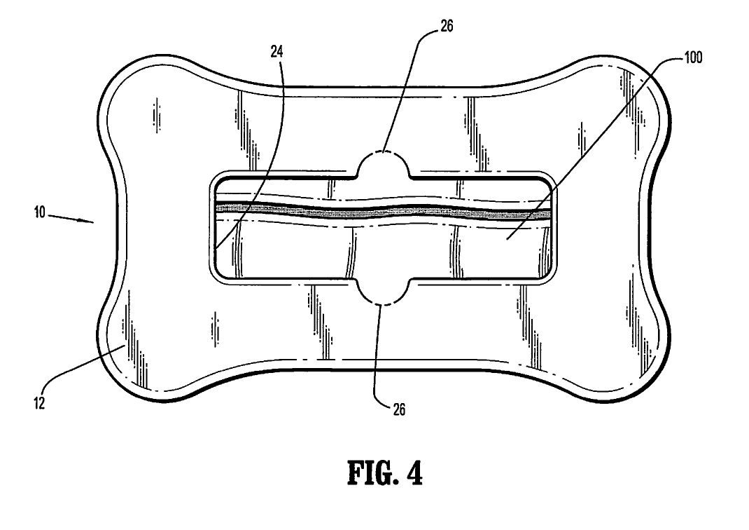

Referring now to FIG. 1-4, there is illustrated the dispensing apparatus 10 for storing and dispensing training pads 100 in an individual and/or sequential manner in accordance with the principles of the present disclosure. The design of the dispensing apparatus 10 may be a furniture item which is aesthetically pleasing and non-obtrusive to the room in which it is stored. The dispensing apparatus 10 includes a base 12, a lid 14 mounted to the base 12, and at least one training pad 100 contained within the internal chamber 16 of the base 12. Preferably, a plurality of training pads 100 are disposed and arranged in at least partial superposed relation within the internal chamber 16 of the base 12 as will be discussed. The base 12 may be generally rectangular in shape having front, rear and side walls 12f, 12r and 12s and base bottom 12b. Other shapes for the base 12 are envisioned. The base 12 defines a base axis “b” (FIG. 2) which may be a vertical axis when the base 12 is placed on a horizontal surface such as a floor or counter top.

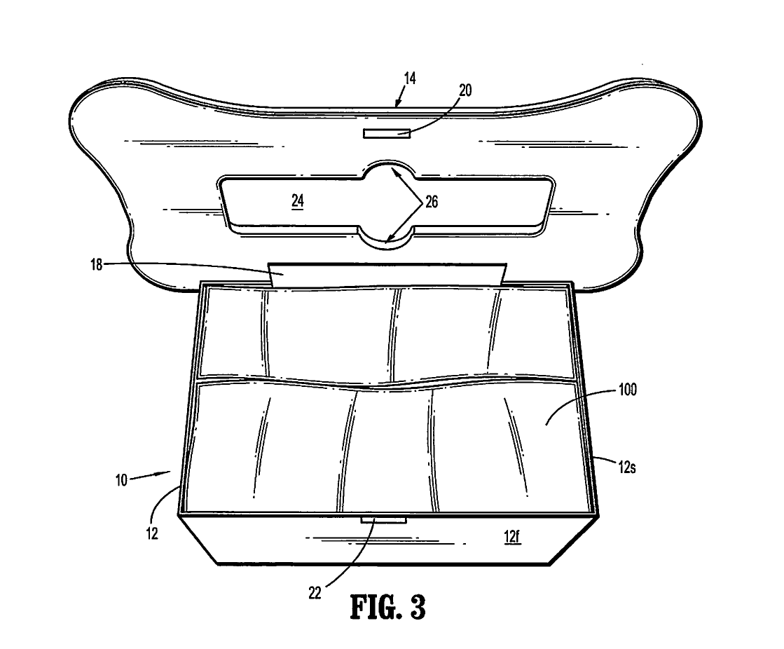

The lid 14 is pivotally mounted to the base 12 and is adapted to pivot between a closed position depicted in FIG. 1 enclosing the training pads 100 and an open position depicted in FIG. 3 permitting access to the chamber 16 within the base 12 to permit selective reloading of new training pads 100 as desired. At least once hinge 18 is connected to the lid 14 and the base 12, and establishes the pivot axis about which the lid 14 pivots. Other means for mounting the lid 14 to the base 12 are also envisioned. It is further contemplated that the lid 14 may be releasably mounted to the base 12, and completely removed from the base 12 to permit access to the internal chamber 16 of the base 12. Clasps, locks or a tolerance fit established between the base 12 and the lid 14 may be used to permit this removable mounting capability. The base 12 and the lid 14 may further include a locking mechanism to releasably secure the lid 14 in the closed position of FIG. 1. One locking mechanism may be a magnetic locking clasp 20 (FIG. 3) mounted to the underside of the lid 14, which cooperates with a magnetic locking clasp 22 on the face of the front base wall 12f. Other clasp arrangements including mechanical locks, hooks or the like are also envisioned.

With continued reference to FIGS. 1-4, the lid 14 includes a central lid aperture 24 of general rectangular shape although other shapes are envisioned. At about the center of the lid aperture 24 are opposed recesses 26. The recesses 26 may be arcuate in shape. The recesses 26 provide additional room for the user to place his/her fingers when accessing the central lid aperture 24 during grasping of the training pad 100 for removal. The lid 14 may have an aesthetically pleasing dog bone design although other configurations are also envisioned.

The base 12 and the lid 14 may be formed from any rigid material including metal, wood and/or molded polymeric material.

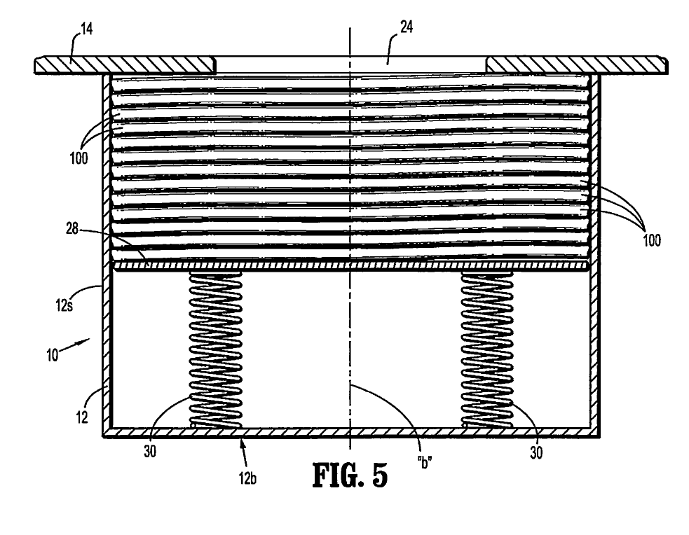

With reference now to FIG. 5, in conjunction with FIGS. 1-4, disposed within the internal chamber of the base 12 is a mechanism for automatically and sequentially feeding the training pads 100 toward the lid 14 for removal through the central lid aperture 24. In one embodiment, the mechanism includes an internal support 28 and at least one, two or even more springs 30 mounted to the bottom of the base 12 and engaging the lower side of the support 28. The springs 30 may be secured to both the bottom of the base 12 and the support 28 through conventional means, including, e.g., welding, soldering, adhesives or the like. The effective spring constant of the springs 30 is selected to continuously urge the support 28 in the vertical direction along the base axis “b” toward the lid 14 even in the presence of a stacked set of training pads 100. The springs 30 may be coiled spring arrangements. Other means for urging or biasing the support 28 are envisioned including resilient elastomers, hydraulics, etc. The support 28 may be rectangular in configuration corresponding in dimension to the internal area of the chamber of the base 12. In use, the top training pad 100 adjacent the lid 14 is removed via access through the central lid aperture 24 whereby, upon removal, the next training pad 100 immediately beneath the removed pad 100 is presented to the lid aperture 24 via the biasing effect of springs 30 relative to support 28 for subsequent removal.

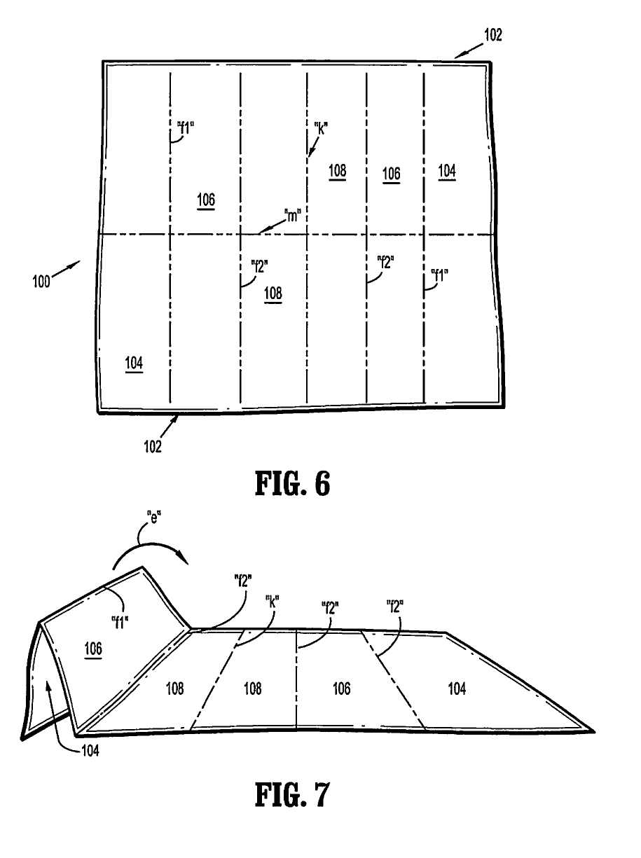

With reference to FIG. 6, in conjunction with FIG. 1, the training pads 100 for use with the apparatus 100 will be discussed. The training pad 100 may be a large and super-absorbent training pad which may be specially treated to attract the pet, e.g., a puppy or dog, to eliminate on the pad. The pad 100 may include a back sheet, a top sheet and an absorbent core between the back sheet and the top sheet. A number of commercially available training pads may be modified for use with the apparatus 10. One suitable pad is the Four Paws Wee Wee pad. Another suitable training pad is disclosed in U.S. Patent Publication Nos. 2008/0236504 and US2006/0260559, and U.S. Pat. No. 7,249,570, the entire contents of each disclosure being incorporated by reference herein.

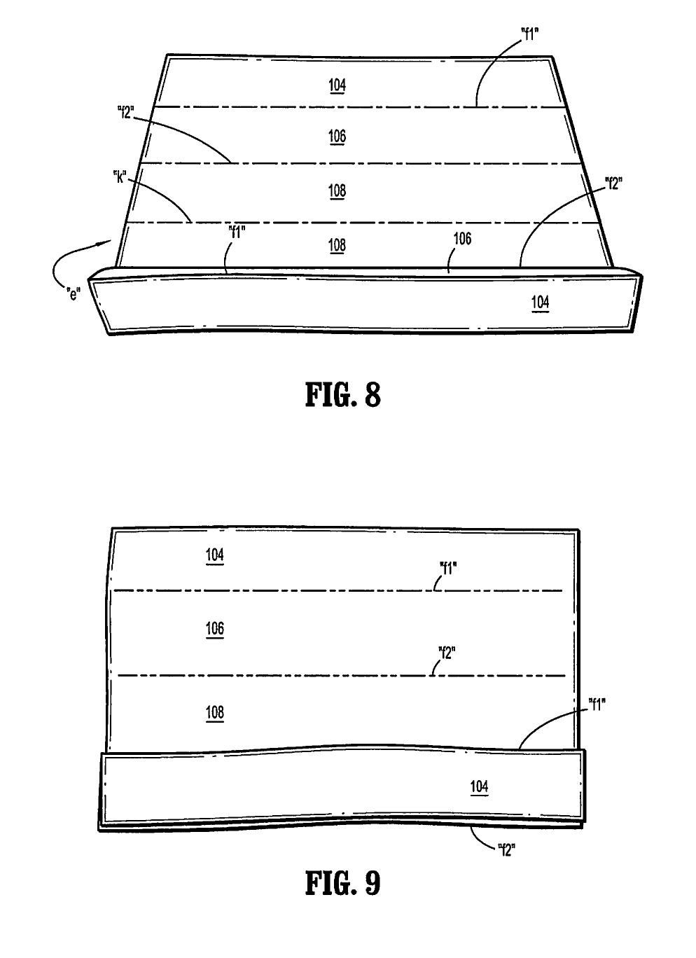

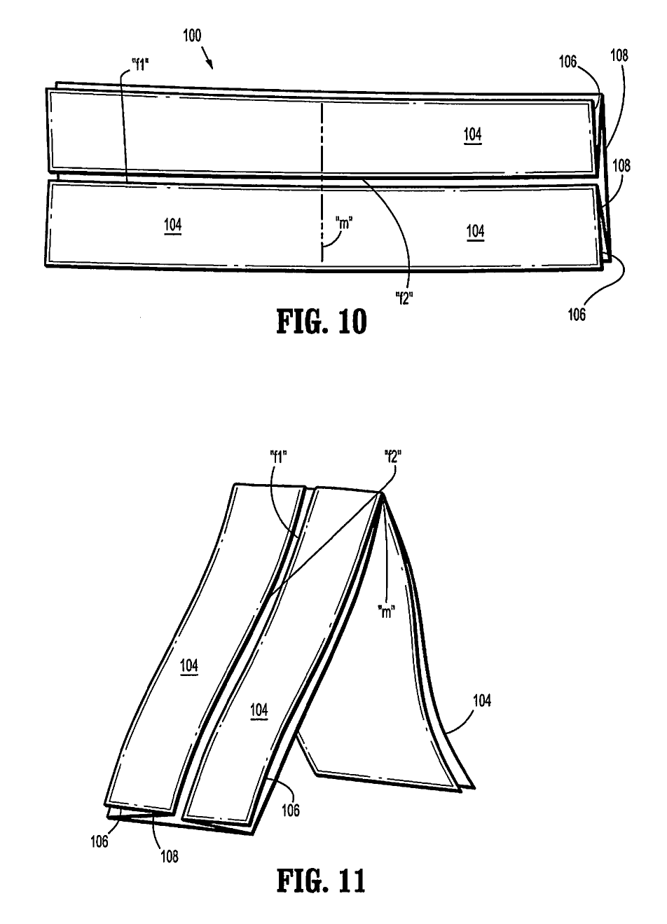

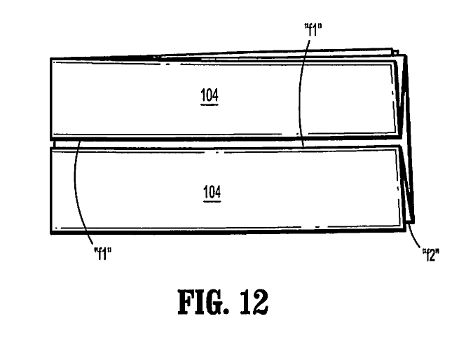

In accordance with an aspect of the disclosure, the training pad 100 is folded in a manner which presents opposed edges of the training pad 100 to the central lid aperture 24, which facilitates removal of the pad 100 from the base 12. Generally, the training pad 100 is rectangular, square or circular in configuration when laid out flat defining a longitudinal midline “k” and a transverse midline “m” as depicted in FIG. 6. The longitudinal midline “k” divides the training pad into longitudinal half sections 102. Each longitudinal half section 102 has two longitudinal fold lines “f1”, “f2” establishing three longitudinal subsections 104, 106, 108. To fold the training pad 100 in accordance with the principles of one embodiment of the present disclosure, the first longitudinal subsection 104 is folded along fold line “f1” and toward subsection 106 as depicted in FIGS. 7 and 8. Folding is continued by folding subsections 104, 106 along fold line “f2” in the direction of directional arrow “e” (FIGS. 7 and 8) to place the three subsections 104, 106, 108 in the at least partial superposed relation depicted in FIG. 9 with subsection 108 on the bottom, subsection 104 on top and subsection 106 between the subsections 104, 108. The panels or subsections 104, 106, 108 of the second or remaining half section 102 may be folded in the same manner such that the pad is in the arrangement depicted in FIG. 10. The training pad 100 may then be folded along the transverse midline “m” as shown in FIG. 11 to assume the arrangement depicted in FIG. 12. The training pad 100 is folded in a manner which will expose the fold lines “f1” or edges defined along or adjacent the intersection of panels 104, 106 outwardly relative to the folded pad 100. It is noted that the fold lines “f1”, “f2” may be made during manufacture of the training pad 100 through a scoring or pressing process, or created during the folding process, i.e., the fold lines do not require to be predefined within pad 100, but may be established upon folding the pad 100 upon itself.

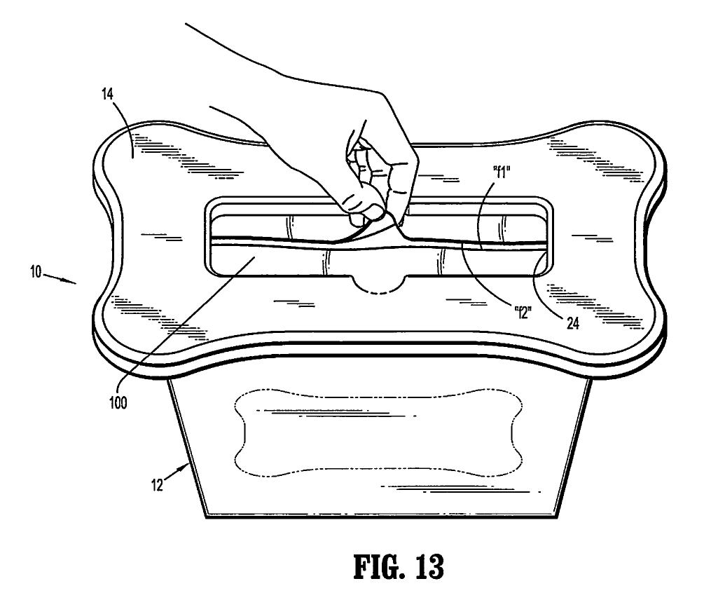

Each training pad 100 may be folded in the same manner and stacked for disposition within the internal chamber of the base 12. The stacked relation is depicted in FIG. 5. The training pads 100 are stacked such that the edges or fold lines “f1” face upwardly toward the lid aperture 24 of the lid 14. The training pads 100 are removed individually by grasping one or more of the exposed edges defined adjacent fold lines “f1” and removing the upper most training pad 100 through the central lid aperture 24 as shown in FIG. 13. Upon removal of the upper most training pad 100, the training pad 100 immediately beneath the removed pad 100 is presented to the lid aperture 24 via the biasing effect of springs 30 relative to support 28 as discussed hereinabove.

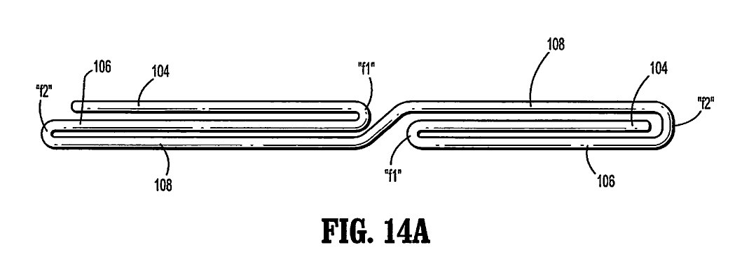

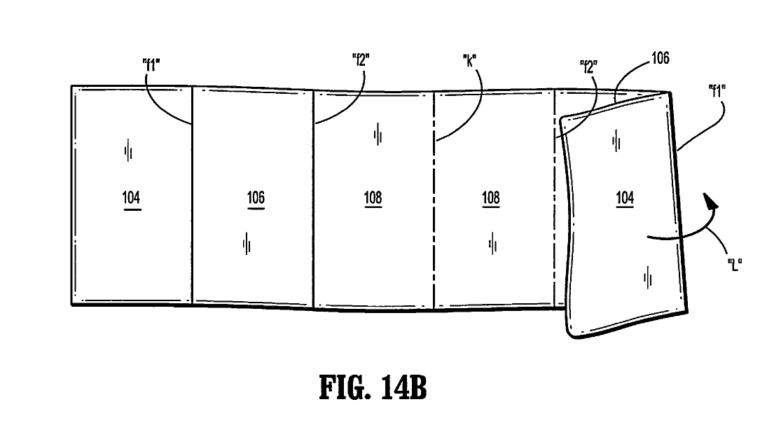

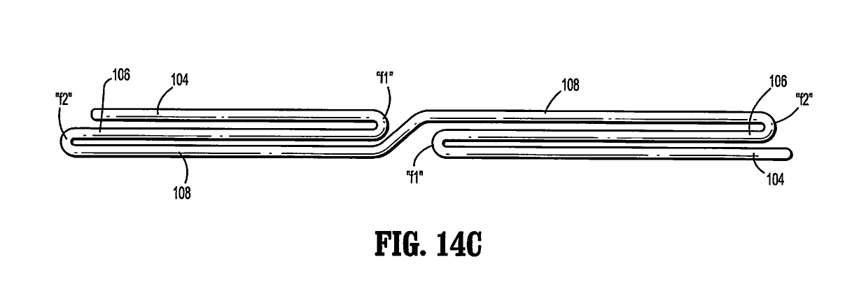

In an alternate method of folding the training pad 100, the first longitudinal section 102 may be folded in accordance with the process described in connection with FIGS. 6-9. The panels or subsections 104, 106, 108 of the remaining longitudinal section 102 may be folded along the fold lines “f1”, “f2” in opposite directions such that the fold line or edge “f1” of the remaining longitudinal section 102 is on the side opposite of the fold line “f1” of the folded pad 100. For example, with reference to FIG. 7, after initial folding of panel 104 onto panel 106, the folded panels 104, 106 may be folded in the direction opposite to the directional arrow “e” along fold line “f2” thus producing the arrangement depicted in FIG. 14A where one fold line “f1” of the first longitudinal section 102 faces upwardly and the other fold line “f1” of the second longitudinal subsection 102 is disposed beneath the first fold line “f1”. In another alternate sequence, with reference to FIGS. 14B-14C, panel 104 may be folded in the opposite direction onto panel 106 to achieve the orientation depicted in FIG. 14B, and the folded panels 104, 106 are folded in the direction of directional arrow “l” (into the plane of the paper) to produce the arrangement depicted in FIG. 14C. In addition, with either of the arrangements described in FIGS. 14A-14C, the folded pad may then be folded along the transverse midline “m” (see, e.g., FIG. 11) to position at least one edge or fold line “f1”, “f2” in alignment with the lid aperture 24 of the lid 14.

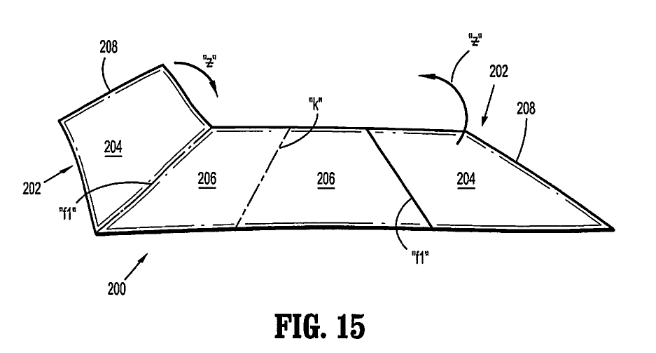

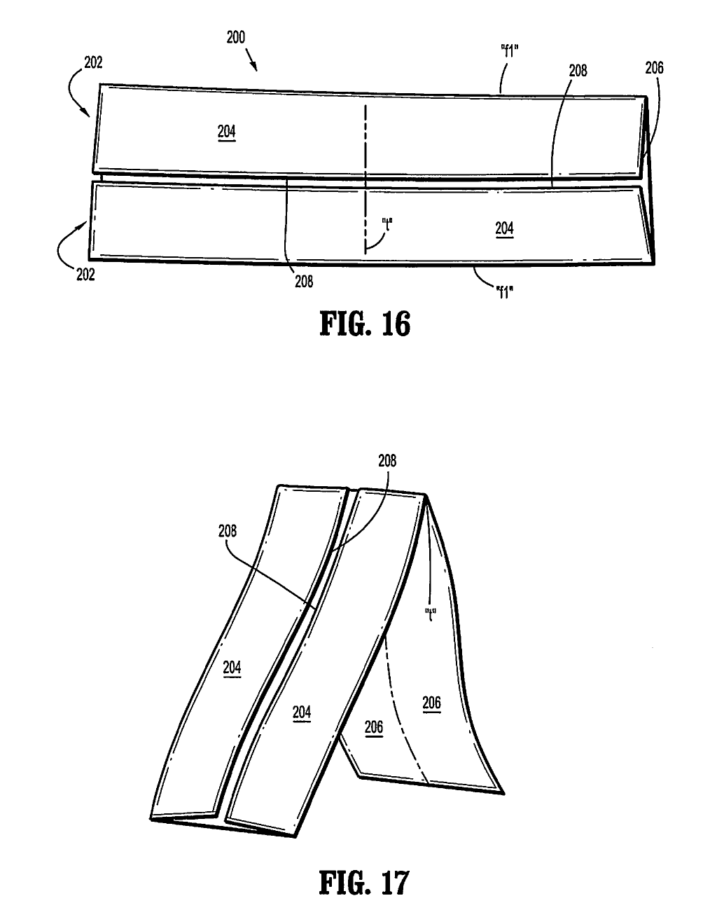

Other ways to fold the training pad are also envisioned. For example, with reference to FIGS. 15-16, the training pad 200 may be sized to define a central longitudinal midline “k” with first and second longitudinal sections 202 each having one longitudinal fold line “f1” to define panels or subsections 204, 206. Each subsection 204 may be folded along the longitudinal fold line “f1” onto the subsection 206 (in the direction of directional arrow “z”) such that the subsections 204, 206 are in at least partial superposed relation. In accordance with this methodology and embodiment, outer peripheral edges 208 of each longitudinal section 202 of the training pad 200 will be positioned in juxtaposed relation adjacent the central longitudinal midline “k” (FIG. 16). A plurality of pads 200 may be folded in this manner. The folded pads 200 may be positioned within the internal chamber 16 of the base 12. Alternatively, depending on the size of the training pad 200, each training pad 200 may be folded along a transverse fold line “t” (FIG. 17) and positioned within the internal chamber 16 with the outer edges 208 facing the lid aperture 24 of the lid 14.

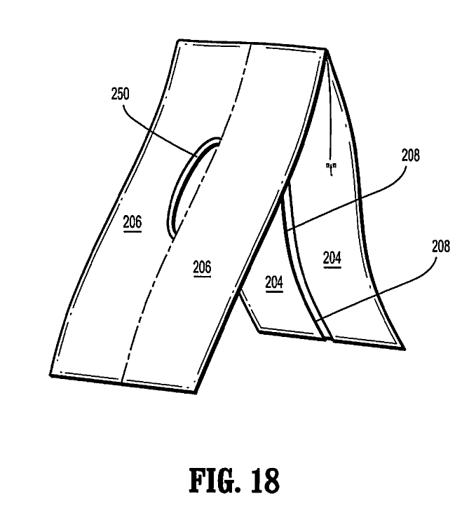

In the afore-described embodiments, at least one edge or possibly two edges of the folded training pad 100, 200 are exposed to face the lid aperture 24 for access through the lid 14. The edges to be grasped by the user may be the edges formed along fold lines of adjacent panels of the training pad such as the arrangement in the embodiment of FIGS. 6-12 and 14A-14C or may be an outer peripheral edge 206 of the training pad such as the arrangement disclosed in the embodiment of FIGS. 15-16. Both folding methodologies will present an edge which can be grasped by the pet owner. Other fold arrangements are also envisioned including methodologies which do not present an edge to the lid aperture 24. For example, with reference to FIG. 18, the training pad 200 of the embodiment of FIGS. 15-17 may be folded along transverse fold line “t” in the opposite direction such that the backing sheet is exposed and no fold lines or edges are outwardly presented. As an alternative, the backing sheet may have a handle 250 which is presented to the lid aperture 24. The handle 250 may be any loop member, tab or element secured to the backing sheet by conventional means including bonding, adhesives or the like.

The present disclosure is also directed to a kit incorporating the dispensing apparatus 10 pre-loaded with a plurality of training pads 100, 200 arranged in the stacked manner in accordance with any of the embodiments discussed hereinabove.

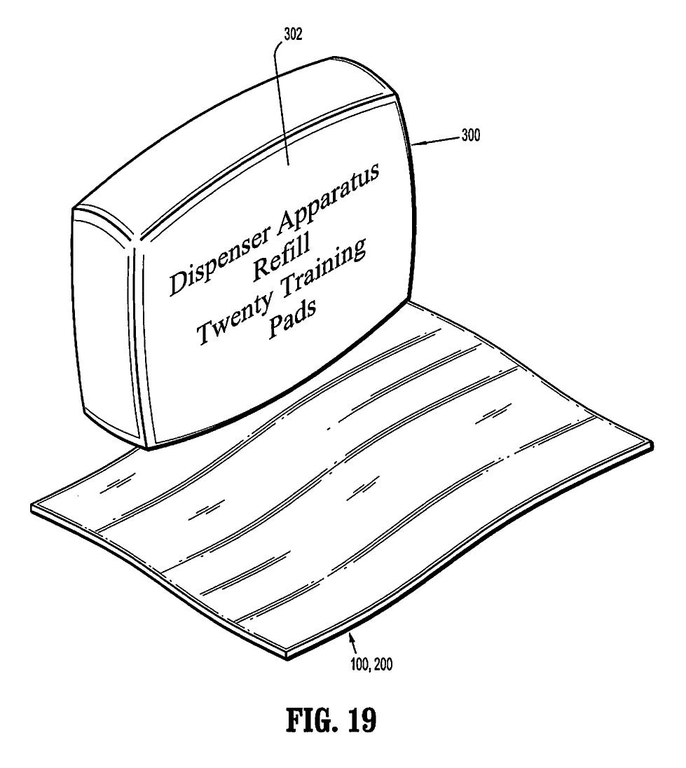

With reference to FIG. 19, the present disclosure also contemplates a replacement package 300 filled with the stacked training pads 100, 200. Once the dispenser apparatus 10 is empty, the lid 14 can be moved to the open position. A new set of training pads 100, 200 are removed from the package 300 and loaded within the internal chamber 16 of the base 12. The package 300 may include an outer wrapping or cover 302 which contains the training pads 100, 200 arranged in the stacked manner with at least one edge outwardly exposed and facing in the same direction as discussed in connection with any of the embodiments and/or methodologies.

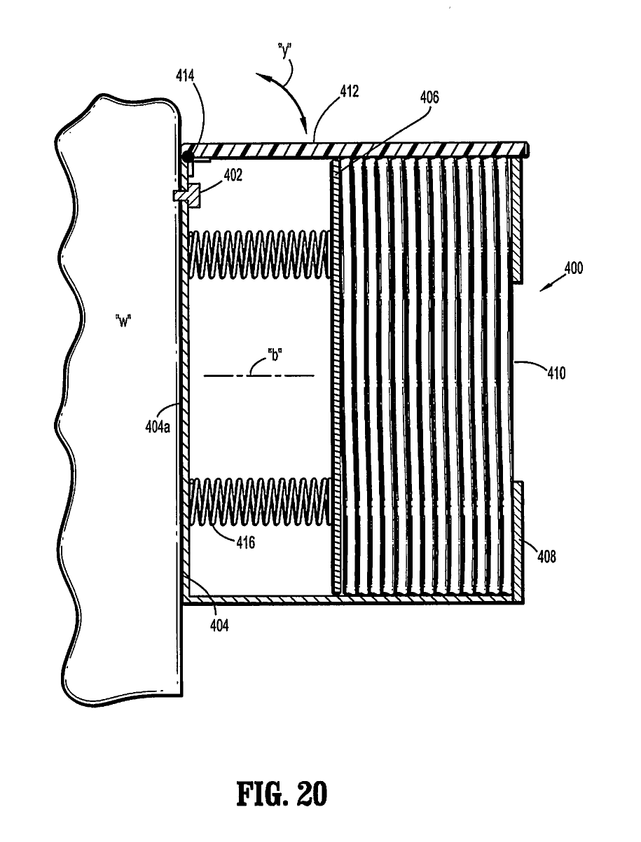

FIG. 20 illustrates an alternate embodiment of the dispenser apparatus of FIG. 1. Dispenser apparatus 400 is intended to be mounted to a vertical surface such as a wall or door “w”. Any means for mounting the dispenser apparatus 400 are envisioned including screws, fasteners or the like. In one embodiment, fasteners or hooks 402 mounted to the wall “w” extend within corresponding apertures within the back 404a of base 404 to mount the base 404 to the wall. In accordance with this embodiment, the support 406 is adapted to translate along a base axis “b” which may be parallel to the floor, e.g., horizontal. In addition, the base 404 defines a front face 408 which has the access opening 410 defined therein for removal of the stored training pads 100, 200. A horizontal lid 412 is mounted to the back wall 404a of the base 404 via a pivot pin 414 or the like and can pivot in the direction of directional arrows “y” between open and closed positions to permit loading of the base 404 with the training pads 100, 200. A pair of coil springs 416 will bias the support 406 toward the front face 408 and the access opening 410 to advance the forward most pad 100, 200 toward the access opening 410. The training pads 100, 200 are arranged in juxtaposed relation possibly with at least one edge of the pads 100, 200 facing the access opening 410 for engagement by the user.

Although the illustrative embodiments of the present disclosure have been described herein with reference to the accompanying attachments, the above description, disclosure, and figures should not be construed as limiting, but merely as exemplifications of particular embodiments. It is envisioned that a varied number of subpanels and edges or fold lines may be incorporated within the training pad 100, 200 and folded accordingly to expose the edges defined between subsections or panels for grasping by the user. Alternatively, no edges of the training pads 100, 200 need to be exposed. It is to be understood, therefore, that the disclosure is not limited to those precise embodiments, and that various other changes and modifications may be effected therein by one skilled in the art without departing from the scope or spirit of the disclosure.

What is claimed is:

1. An apparatus for dispensing pet training pads, which comprises:
a base defining a base axis and having an internal chamber; and
a support disposed within the internal chamber of the base, the support arranged to support at least two pet training pads in superposed relation, the support dimensioned and adapted to translate within the internal chamber along the base axis to direct the pet training pads toward an access opening associated with the base to permit sequential removal of the training pads through the access opening by the user.

2. The apparatus according to claim 1 including a biasing member in operative engagement with the support, the biasing member dimensioned to bias the support to translate along the base axis toward the access opening.

3. The apparatus according to claim 2 wherein the biasing member includes a spring, the spring disposed in operative engagement with the support.

4. The apparatus according to claim 3 including first and second springs in operative engagement with the support and cooperating to bias the support toward the access opening.

5. The apparatus according to claim 2 including a lid mounted to the base, the lid defining a lid aperture, the lid aperture being the access opening.

6. The apparatus according to claim 5 wherein the lid is adapted to move between an open position to permit loading of the internal chamber of the base with training pads and a closed position to substantially enclose the internal chamber.

7. The apparatus according to claim 6 wherein the lid is pivotally mounted to the base, and is adapted to pivot between the open position and the closed position.

8. The apparatus according to claim 1 including a plurality of pet training pads arranged in superposed relation within the internal chamber of the base.

9. The apparatus according to claim 8 wherein each training pad is folded and has at least a first edge, the first edge positioned in general alignment with the access opening to face the opening to thereby facilitate grasping of the training pad by the user.

10. The apparatus according to claim 9 wherein each training pad is folded to define at least first and second edges, the first and second edges being in juxtaposed relation and positioned in general alignment with the access opening to face the opening to thereby facilitate grasping of the training pad by the user.

11. The apparatus according to claim 1 including a package, the package including an outer cover and a plurality of pet training pads in superposed relation within the outer cover, the outer cover being removable to permit removal of the training pads for positioning within the internal chamber of the base.

12. The apparatus according to claim 11 wherein each training pad is folded and has at least a first edge, the first edges of the pads facing in a same direction within the package.

13. The apparatus according to claim 12 wherein each training pad is folded to define at least first and second edges, the first and second edges of each training pad being in juxtaposed relation and positioned in the same direction within the package.

14. A package for use with a dispenser, which comprises:
an outer cover; and
a plurality of absorbent pet training pads at least partially enclosed by the outer cover, each training pad folded upon itself to define a folded training pad, each folded training pad having at least one edge exposed outwardly of the folded training pad, at least some of the folded training pads arranged in superposed relation with the at least one edge facing in the same direction within the outer cover.

15. The package according to claim 14 wherein each folded training pad has at least first and second edges exposed outwardly of the folded training pad, at least some of the folded training pads arranged in superposed relation with the first and second edges facing in the same direction within the outer cover.

16. The package according to claim 15 wherein each training pad defines a central longitudinal midline dividing the training pad into longitudinal sections, and at least one substantial longitudinal fold line on each side of the central longitudinal midline, each longitudinal section folded upon itself along the at least one longitudinal fold line thereby providing first and second edges adjacent the longitudinal midline.

17. The package according to claim 16 wherein each training pad includes and at least two substantial longitudinal fold lines on each side of the central longitudinal midline, each longitudinal section folded upon itself along the at least two longitudinal fold lines thereby providing first and second edges adjacent the longitudinal midline.

18. The package according to claim 17 wherein each training pad defines a medial transverse medial fold line orthogonal to the central longitudinal midline to define first and second transverse sections of each training pad, the first and second transverse sections folded onto each other along the medial fold line to present the first and second edges outwardly of the folded training pad.

19. A method, comprising the steps of:
a) providing a plurality of absorbent pet training pads, each training pad defining a central longitudinal axis and a transverse axis orthogonal to the central longitudinal axis, each pet training pad having first and second longitudinal sections defined on respective sides of the central longitudinal axis;
b) folding the first longitudinal section of each training pad along at least one longitudinal fold line extending within the first longitudinal section to position a first edge of the training pad adjacent the central longitudinal axis;
c) folding the second longitudinal section of each training pad along at least one longitudinal fold line extending within the second longitudinal section to position a second edge of the training pad adjacent the central longitudinal axis;
d) positioning the training pads within an internal chamber of a dispenser in superposed relation such that the first and second edges of each training pad face outwardly toward an access opening of the dispenser;
e) moving a support within the internal chamber of the dispenser to advance the training pads toward the access opening; and
f) removing the outermost training pad adjacent the access opening from the dispenser by grasping the outermost training pad adjacent at least one of the first and second edges thereof.

20. The method according to claim 19 wherein the step of folding the first longitudinal section includes folding the first longitudinal section onto itself along at least two longitudinal fold lines and wherein the step of folding the second longitudinal section includes folding the second longitudinal section onto itself along at least two longitudinal fold lines.

21. The method according to claim 20 including the step of folding the training pad along the transverse axis whereby the first and second edges face outwardly relative to the training pad.

22. The method according to claim 19 wherein the dispenser includes a biasing member disposed therein in operative engagement with the support and wherein the step of moving includes urging the support with the biasing member toward the access opening.

23. The method according to claim 19 wherein the dispenser includes a lid and wherein the step of positioning the training pads includes opening the cover to provide access to the internal chamber.

24. The method according to claim 23 wherein the lid defines a lid aperture, the lid aperture being the access opening when the lid is in a closed position, and wherein the step of removing the outermost training pad includes removing the outermost training pad through the lid aperture.
